(19) United States
(12) Patent Application Publication
(10) Pub. No.: US 2005/0114240 A1
(43) Pub. Date: May 26, 2005

(54) Bidirectional interfaces for configuring OSS components

(76) Inventors: Brett Watson-Luke, Indooroopilly (AU); Nigel Waddington, Wavell Heights (AU)

Correspondence Address: Schwegman, Lundberg, Woessner & Kluth, P.A., P.O. Box 2938, Minneapolis, MN, 55402, US

(21) Appl. No.: 10/723,582

(22) Filed: Nov. 26, 2003

(51) Int. Cl. G06F 17/60

(52) U.S. Cl. 705/34

(57) ABSTRACT

The present inventive subject matter relates generally to the field of operational support system software and more particularly to component configuration interfaces used in operational support systems. The present inventive subject matter includes systems and methods for one more component programs operable on the system that manage configuration of software over bidirectional interfaces that allows communication between components. Such individual components are master to some configuration settings and slave to other configuration settings. In some examples with respect to a specific configuration setting, a master sends updates over the bidirectional interface to slave components according to a received configuration modification.

### RELATED FILES

This invention is related to the following cofiled, coassigned and copending applications:
Application Ser. No. ______, filed Nov. 26, 2003, entitled “SYSTEMS, METHODS AND SOFTWARE TO CONFIGURE AND SUPPORT A TELECOMMUNICATIONS SYSTEM” (Attorney Docket No.: 500.825US1);
Application Ser. No. ______, filed Nov. 26, 2003, entitled “SYSTEM AND METHOD FOR HIERARCHICALLY REPRESENTING CONFIGURATION ITEMS” (Attorney Docket No.: 500.828US1);
Application Ser. No. ______, filed Nov. 26, 2003, entitled “SYSTEM AND METHOD FOR CONFIGURING A GRAPHICAL USER INTERFACE BASED ON DATA TYPE” (Attorney Docket No.: 500.829US1);
Application Ser. No. ______, filed Nov. 26, 2003, entitled “SYSTEM AND METHOD FOR MANAGING OSS COMPONENT CONFIGURATION” (Attorney Docket No.: 500.827US1); and
Provisional application Ser. No. ______, filed Nov. 26, 2003, entitled “SYSTEMS, METHODS AND SOFTWARE TO CONFIGURE AND SUPPORT A TELECOMMUNICATIONS SYSTEM” (Attorney Docket No.: 500.831PRV); all of the above which are hereby incorporated by reference.

### Limited Copyright Waiver

A portion of the disclosure of this patent document contains material to which the claim of copyright protection is made. The copyright owner has no objection to the facsimile reproduction by any person of the patent document or the patent disclosure, as it appears in the U.S. Patent and Trademark Office file or records, but reserves all other rights whatsoever.

### FIELD

This invention relates generally to the field of operational support system software and more particularly to component configuration interfaces used in operational support systems.

### BACKGROUND

Telecommunications service providers typically use several different software systems to provide provisioning, billing and customer support. These systems are typically developed by a vendor in one or more “generic” forms, and then custom configured to support the particular product or service offerings of a particular telecommunications service provider. As the products or services offered by a provider are constantly in flux, there is an almost constant need to reconfigure these software systems to support the new or modified offerings. Each of these reconfigurations may result in new versions of the software being developed, tested, and installed. Accordingly, reducing the time and effort required to configure and reconfigure such software is desirable.

### BRIEF DESCRIPTION OF THE DRAWINGS

FIGS. 1 to 5 depicts an example embodiment according to the inventive subject matter described herein.

FIG. 6 is a block diagram according to an example embodiment according to the inventive subject matter described herein.

FIG. 7 is a block diagram according to an example embodiment according to the inventive subject matter described herein.

### DETAILED DESCRIPTION

In the following detailed description, reference is made to the accompanying drawings that form a part hereof, and in which are shown by way of illustration specific embodiments in which the invention may be practiced. It is understood that other embodiments may be utilized and structural changes may be made without departing from the scope of the present invention.

The leading digit(s) of reference numbers appearing in the Figures generally corresponds to the Figure number in which that component is first introduced, such that the same reference number is used throughout to refer to an identical component which appears in multiple Figures. Signals and connections may be referred to by the same reference number or label, and the actual meaning will be clear from its use in the context of the description.

Definitions

The following definitions are used herein:

| Term | Definition |
|---|---|
| API | Application programming interface |
| CB | Convergent billing |
| CM | Customer management |
| CRUD | Create, Read, Update, Delete (operations performed |
| | on or with data) |
| CS | Configuration Server |
| CVS | Concurrent version systems |
| DAO | Data access object |
| EJB | Enterprise Java beans |
| GPL | GNU General Public License |
| GUI | Graphical user interface |
| IDE | Integrated development environment |
| J2EE | Java 2 enterprise edition. A specification for an execution |
| | environment for enterprise applications written in Java. It |
| | includes EJB and JMS. |
| J2SE | Java 2 standard edition. |
| JAAS | Java authentication and authorization service |
| JMS | Java messaging service |
| JNDI | Java Naming Directory Interface |
| JRE | Java runtime-environment. |
| JVM | Java virtual machine |
| LMS | Lifecycle Management. |
| MDB | Message driven beans |
| MOM | Message oriented middleware |
| OSS | Operational support systems |
| RDBMS | Relational database management system |
| SAF | Server Administration Functions |
| SOAP | Simple Object Access Protocol |
| Swing | User interface toolkit that is part of J2SE |
| UI | User interface |
| W3C | World wide web consortium |
| XML | Extensible markup language |
| XML Schema | A W3C recommendation for expressing schemas |
| | (structure and valid content) of XML documents. |
| XPath | XML Path Language |

Overview of System Architecture

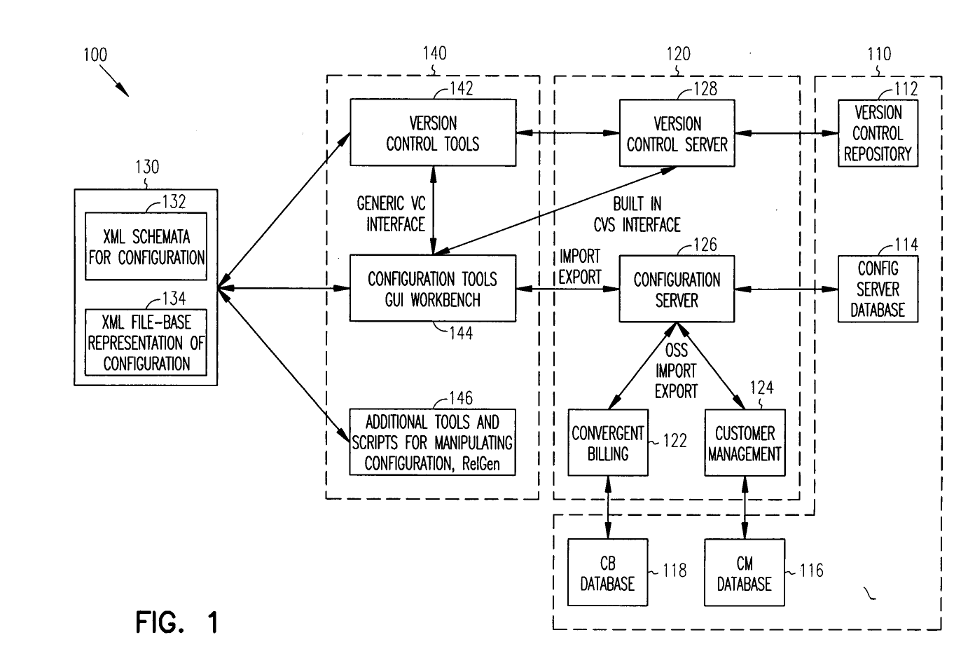

FIGS. 1 to 5 depicts an example embodiment according to the inventive subject matter described herein. In FIG. 1 there is illustrated the major system components of a Lifecycle Management Suite (LMS) according to this example embodiment. Components 100 include data-stores 110, server components 120, file-based data 130, and configuration tools (alternately referred to as the “configuration toolkit”) 140.

APIs exist within the convergent billing (CB) 122 and customer management (CM) 124 OSS components for manipulation of the configuration. The nature of the APIs varies between these systems and depending on the configuration item, but they provide the ability to create, update and delete or obsolete configuration items in these systems. These APIs may be, however, low level—they deal with configuration in the terms of the OSS components. A function of LMS 140 is to provide higher-level configuration items, such as the high-level product catalog items (that span multiple OSS components), or configuration policies and composite configuration items. The configuration server 126 stores these higher level representations of configuration. It can be used to query the configuration in the OSS components, and to update it. It sends messages to OSS components when configuration data is updated.

Tools 144 may be provided that can extract configuration from these systems, to an external file-based form, where it may easily be manipulated using file-based tools and to load the configuration from its file-based representation back into the OSS components. These are part of the configuration tools user interface. These tools 144 interact with the OSS components via the configuration server 126.

In order to manage the configuration effectively, version control tools 142 may be provided. These are applied to the file-based data/representation 130 of the configuration. These include basic tools for committing changes to configuration, viewing differences between configuration, and grouping configuration items, for version control purposes.

In order to develop products quickly and simply, a workbench development tool (shown in block 144) may be provided. This GUI application can work either off a file-based representation of the product definitions, or by communicating with the configuration server 126, via its APIs.

The XML schemata 132, depicted as “interacting” with the file-based representation of the configuration 134 are the documents that define the structure of the configuration data in its file-based form. Tools and developers can use the knowledge embedded in these schemas in order to assist them in reading or processing the configuration. FIG. 1 further depicts additional tools 146 interacting with the file-based representation of the configuration.

Configuration APIs

The configuration APIs provide access to the configuration data in CB 122 and CM 124. On top of these, the configuration server 126 provides a unified API for accessing the configuration in the OSS. The API is, in one example embodiment, required to provide:
Create, read, update, delete operations.
Validation.
Searching.
Post commit notifications.
   Execution Environment

The CB 122 and CM 124 configuration APIs may be part of the CB 122 and CM 124 servers, and may execute on any platform on which these OSS components are available. The general configuration API may be part of the configuration server 126, and executes on the supported platforms for the configuration server 126.

OSS Import and Export

Overview

The terms import and export are used, respectively, to mean obtaining configuration data from the OSS so that it can be placed into the configuration repository, and to load the configuration data back into the OSS. In some embodiments, requirements for these components include the following functionality:
The ability to perform export operations on groups of configuration items.
The ability to support multiple versions of OSS components.

In various embodiments, supported versions of CB 122 and CM 124 are supported by the import and export tools. The implications of this may be significant:
The configuration items that apply for the various versions of the product differ between releases.
The attributes of some configuration items differ between releases.
Validations and business rules that apply to various configuration items differ between releases.
The API for accessing the configuration items can vary between releases.
The transport mechanism for API calls varies between the releases. (Note that the variations may not be just between major releases. Minor releases and maintenance releases may also introduce changes of this nature.)

Import and Export Mechanisms

The import and export functionality may be met in part by functionality provided by the configuration server 126 and in part by functionality provided by the configuration tools GUI.

The configuration server 126 provides an API that allows clients to directly obtain or update a file-based, which in one example embodiment is an XML representation, of the configuration items stored in CB 122 and CM 124. It shall be understood, however, that XML is just one type of file-based form that can be used for this purpose, and that the inventive subject matter hereof is in no way limited to XML file formats. Within the configuration server 126 the import and export operations may be performed by components called publishers. These are described in the Configuration Server section herein.

The GUI provides file/folder explorer views of the configuration server 126 repository that allow imports and exports via menu actions, and allow items to be sent to the OSS via file copy-and-paste operations. The configuration server 126 file system module that provides this functionality is described in the Configuration GUI section herein. An additional module may be provided that makes it easy to move configuration between repositories. This synchronization module is described in the Configuration GUI section herein. When used in conjunction with the configuration server 126 file system module this allows sophisticated selection of configuration to be imported/exported.

The configuration server 126 administration console also provides commands for import/export, and is described in the Configuration GUI section herein.

Data Format

The import may be to an XML format, and the export may be from the XML format (for CB, CM 124 and product catalog configuration).

The product catalog format may be specified as a set of related XML Schemas for the catalogs, categories, charge types and components. The product catalog schemas may be extensible.

Execution Environment

In some embodiments, the import and export related functionality is provided in the configuration server 126 and configuration tools UI.

Version Control System and Tools

Overview

In some embodiments, the implementation of the version control system is based on CVS. However, other similar version control systems are readily available that are capable of performing this function. For information on CVS, see CVS Web site: http://www.cvshome.org for documentation on CVS. The implementation consists of the following components:
CVS server software, for managing the version control repository.
CVS client software, for accessing the version control repository.
Additional support for determining the differences between configuration items in the repository and local changes and for assisting the user to merge them. These operations may be provided in the configuration GUI by the Netbeans modules 510 for CVS. See the Configuration GUI section herein.
Support for grouping configuration, and applying version control operations to the groups. An API is provided to perform grouping operations. A visual representation of groups may be required for usability purposes.
   This is described in the Configuration GUI section herein. The following sections describe the architecture of each of these components.

CVS Server

In CVS embodiments, CVS provides the core version control facilities, and the management of the version control repository.

CVS Client

There may be numerous CVS client applications and libraries available for accessing CVS. In some embodiments, the configuration tools GUI is required to interact with the version control system, and so the CVS client facilities provided is based on the needs of the GUI.

Grouping API

Support for version control operations on groups of configuration are typically required. In order to support these operations, a grouping API is provided, and actions are provided in the configuration tools GUI for performing version control operations on these groups. See the Configuration GUI section herein for details.

The grouping API provides Java classes for manipulating grouping information, and serialization to XML form, and instantiation from XML form. In some embodiments, the following facilities are provided:
JavaBeans may be provided for representing grouping information.
In some embodiments, an XML form is used for grouping information.
The ability to select items from a group in the GUI and apply CVS operations on them.
The ability to select items from a group in the GUI and import or export them from or to the OSS.

Execution Environment

The version control server 128 can be run on any platform that CVS can be ported to. The following platforms are supported in the distributed toolkit: Solaris, AIX, HP/UX.

In some embodiments, the version control client tools require the following execution environment: a system with the JRE version 1.4.1 or later.

Configuration Server

Overview

The configuration server 126, in one example embodiment, is responsible for:
Providing a centralized location that can be queried or accessed to update configuration in the OSS.
Ensuring that configuration is changed consistently across the OSS.
Auditing changes to configuration across the OSS.
Providing notifications to interested parties when configuration changes.
Enforcing security on changes to the configuration.
Enforcing locking on configuration items.

It is possible that composite configuration and higher-level configuration will be specified for future configuration tools releases. The configuration server 126 may store these higher-level configuration items, and may propagate changes to these items to the OSS in the form of the lower level configuration items that may be used to implement the abstractions.

In some embodiments, requirements are specified for a catalog component. According to one example embodiment it is responsible for:
Providing transactional updates to the catalog.
Managing the persistence of the catalog.
Validating updates to the catalog.
Enforcing security on catalog updates and reads.
Auditing catalog changes.
Providing mechanisms for publishing the catalog into OSS systems.
Notifying clients when the catalog changes so they can reflect these changes.
Providing facilities for clients to search the catalog.

That is, the catalog requirements and the configuration server 126 requirements may be practically the same—the commerce index merely represents a subset of the configuration data.

In some embodiments, the major components of the CS are:
The core enterprise Java beans (EJBs) that represent configuration entities and catalog entities and that provide business interfaces to these entities.
Publishing components that push changes to the configuration data into the various OSS.
The persistent store for the configuration data and catalog (database).

The CS runs inside an EJB container. This provides:
A standardized application environment, with proven portability.
Transaction support, including two-phase commit (if required).
Choice in application servers (There may be a multitude of vendors with tested J2EE conformance. See http://java.sun.com/j2ee/compatibility.html).
Security (container managed authorization).
Distributed application server support, failover, etc for high performance and availability, for customers that require it.
Easy integration of EAI tools (via Java APIs, JMS, etc) and OSS components (via Java APIs, or the Java connector architecture).

It should be noted that XML schemas can be used for specifying the catalog data. This does not define the internal representation of the catalog data. Rather, it specifies an externalized form of the catalog data that is suitable for sharing.

Architectural Overview

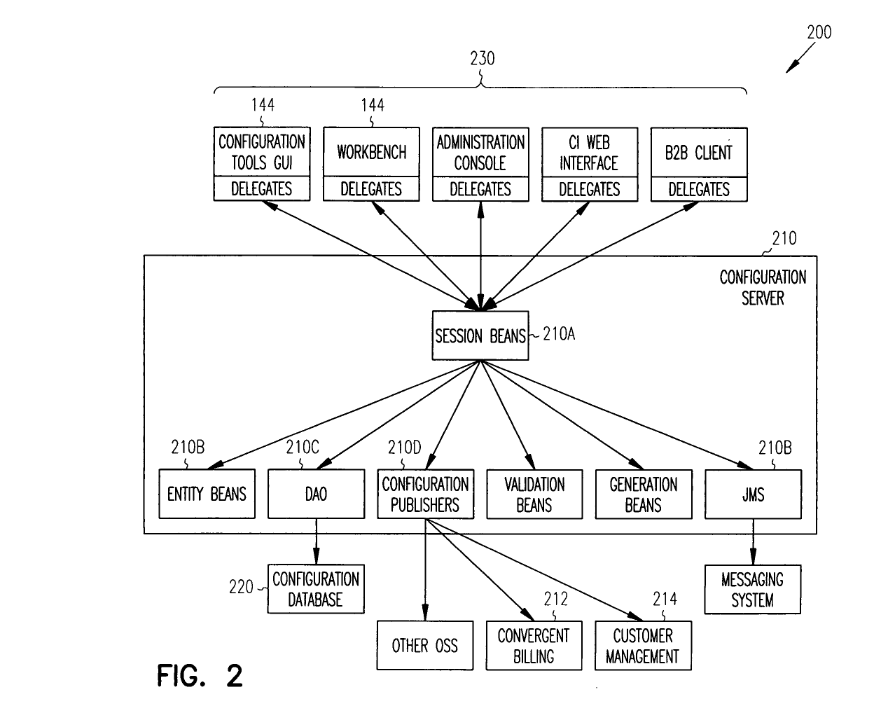

The major components involved in the configuration server 126 and their interactions are depicted in FIG. 2. Server 126 includes a configuration server 210 having components 210a, 210b, 210c and 210d. A catalog database 220 is also included, along with clients 230. Further included are a convergent billing server 212 and a customer management server 214. Note that the set of clients is illustrative only. Only the configuration tools GUI, workbench, and administration console may be part of the LMS according to one example embodiment of the inventive subject matter disclosed herein. The follow sections describe the structure of the server in more detail.

Entity Beans

In some embodiments, entity beans 210b are used to represent the following information in the configuration server 126:
All OSS configuration items.
Categories
Components
Catalogs
Charge types

That is, entity beans exist to represent each of the major data elements.

Data access objects (DAO 210C) may be used to actually read and write the configuration items to persistent storage. By defining a DAO 210C interface, and creating a distinct implementation for the required DBMS we:
Make the entity beans independent of the storage mechanism.
Allow substitution of alternate storage handlers. E.g. the system may initially use a RDBMS, but might use an XML database in order to provide faster searching.

The delivered LMS product uses Oracle 9i as the DBMS, as described below. However, other similar databases are suitable as well.

Validation

Updates to the entities invoke validation classes that ensure that the constraints on the configuration items may be satisfied. All validations adhere to a common interface. The validations are not a fixed set, but may be capable of being augmented by customers deploying the server. They are not statically specified, but may be dynamically located, so that the set of validations can be extended to suit customer requirements (providing validations for additional catalog extensions, for example). In some embodiments, this is achieved as follows:
The session interface class that handles requests to update configuration (see further below) has an environment entry that specifies the validations. The validations may be specified as a list of environment references that can be looked up to locate additional session objects whose primary purpose is to validate configuration items.
There is a common interface that all validation session beans 210a implement. The client session bean uses this interface.
Additional validations may be added simply by registering new validation classes using the standard EJB deployment tools, and by adjusting the environment entry that specifies the home interfaces of these classes.

It should be noted that the OSS components that the server publishes into already have validations in place for the data that they maintain. The configuration server 126 can be made to use these validations by writing validation classes that call appropriate validation logic in the various OSS components. These calls would be made as part of any change transaction. If they fail, the transaction would fail, and if the required OSS system was not available, the transaction would also not be able to proceed. Of course, other validations will be performed when the configuration change is published into each part of the OSS. These may result in the change not being loaded into part of the OSS if the change is not considered valid by some of the systems. See further below for more details of the OSS publishing process.

Session Facades

Although entity beans exist for the configuration and catalog items, they are not accessed directly by any client. Instead, clients access the data through what is known as a “session facade”. See the facade pattern in Design Patterns, Elements of Reusable Object-Oriented Software, ISBN: 0-201-63361-2 and discussions of session facade in a J2EE context in J2EE Blueprints http://java.sun.com/j2ee/blueprints/index.html and Core J2EE Patterns, Best Practices and Design Strategies, ISBN: 0-13-064884-1. Essentially, the session facade provides a business process interface to the configuration server 126 and catalog, while the entity beans map to the data elements. Using session facades has several advantages:
The session can perform a number of create, read, update, and delete operations on behalf of a remote client, reducing network traffic.
The session serves as a transactional facade, ensuring that transactions occur on the server, rather than being managed by clients.

A full discussion of this design pattern can be found in (Core J2EE Patterns, Best Practices and Design Strategies, ISBN: 0-13-064884-1).

The session facades access the CS entities using a local interface. This is an enhancement in EJB 2.0 that allows co-located EJB beans to efficiently access each other (rather than going through a remote interface and incurring the consequent performance impacts).

An important aspect of using a session facade to access the CS is that clients call the session or retrieve from the session value objects that represent the configuration items. This is in contrast to having direct access to the entity beans that represent the configuration item, or passing many arguments to the session beans 210a. See (J2EE Blueprints http://java.sun.com/j2ee/blueprints/index.html) for a discussion of value objects. The value objects:
Are Serializable objects (so they can be used in method calls and return values).
Are representations of the entity beans (domain objects) of the configuration/catalog, and hence can be referred to as domain value objects.
Aggregate value objects are provided that contain multiple related value objects. E.g. a composite catalog which contains a catalog, all its categories, charge types, and components.

Essentially, the session facade acts as a value object factory—that is, it creates value objects corresponding to configuration items and returns them to clients. It also updates configuration entities based on the value objects sent to it by clients.

In the CS, there may be a limited amount of client state required:
User locale information (for returned messages/errors).
OSS authentication details for the user.
User licenses.

In addition, the business processes supported by the configuration server 126/catalog typically involve only a single method call to complete (i.e. they are not conversational). For this reason, the configuration server 126 session beans 210a may be stateless, apart from a bean that stores the limited amount of user state.

In some embodiments, session beans 210a are created to group together logical groups of business processes. In some such embodiments, session beans 210a are provided for the following groups of interactions:
Configuration client interactions.
Catalog client interactions.
Administration interactions.

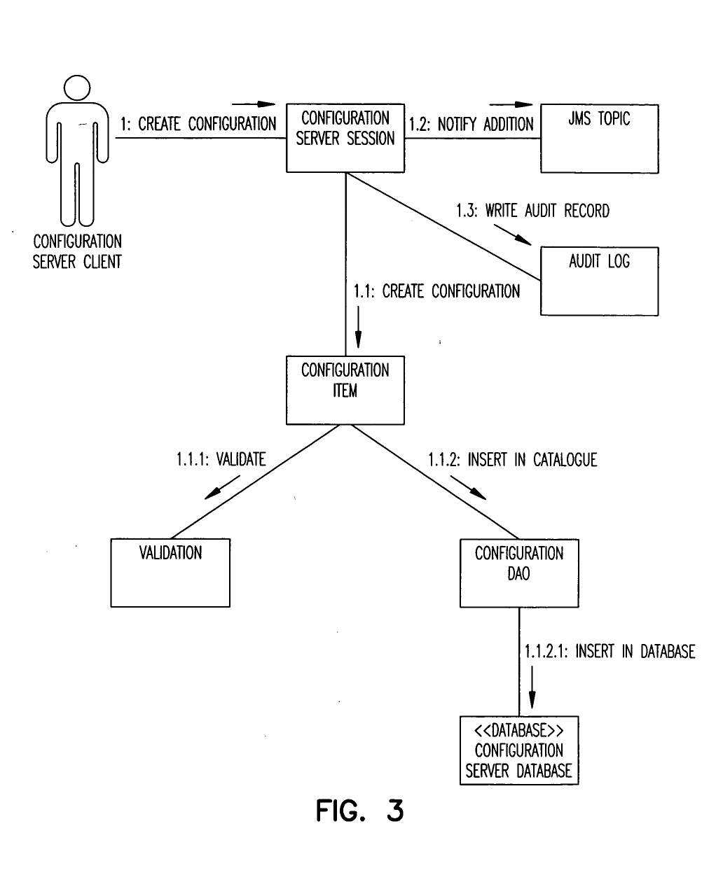

FIG. 3 illustrates how the session beans 210a collaborate with the entity beans to perform the work required by a user interaction. The activities in 1.1, 1.2, and 1.3 all occur within the same transaction. That is, they represent a unit of work that may be committed or rolled back as a unit.

Value List Handlers

Value list handlers may be used to handle search results efficiently. See (Core J2EE Patterns, Best Practices and Design Strategies, ISBN: 0-13-064884-1). They provide an easy to use interface for the client to iterate through search results, while ensuring that clients do not retrieve full results sets over the network when this might be unnecessary. They may be backed using stateful session beans 210a on the server, to hold the search results sets.

Business Delegates

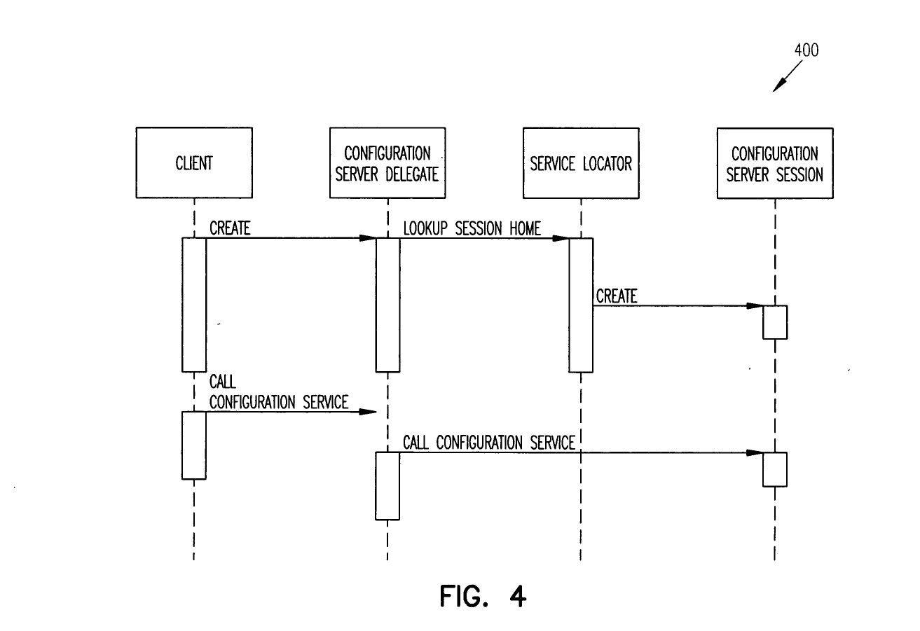

It should be noted that clients that use the session facades should not directly invoke the session objects. Instead they work via objects which reside in the client and which act as proxies and facades (see Design Patterns, Elements of Reusable Object-Oriented Software, ISBN: 0-201-63361-2) and invoke the session objects. These object intercept service exceptions (RMI exceptions due to application server failure or connection failure) and can perform service lookups (lookup the session bean home interfaces via JNDI) and caching. This means that the client does not have to be aware of the implementation of the session as an EJB. In (Core J2EE Patterns, Best Practices and Design Strategies, ISBN: 0-13-064884-1) these objects are referred to as Business Delegates. The business delegates form the client-side API that all of the tools use. The use of Business Delegates is depicted in diagram 400 of FIG. 4.

Notifications

When the configuration entities are updated, the systems that use the server can either be directly informed as part of the update, or informed via notification messages after the update. Components that participate in the update may be referred to as publishers. Components that receive asynchronous notification messages would do so because:
Informing these components may take too long, and involve too much processing.
Some of the components that need to be notified may not be operational. This should not prevent configuration maintenance.
The OSS systems cannot all participate in a single update transaction, due to the lack of 2 phase commit across the OSS.
It may be desired to integrate use the routing and workflow facilities of some 3rd party message-oriented middleware component to integrate with other systems.

Typically the message based notification mechanism cannot be synchronous, and must allow for the notifications to be stored in a persistent store when the systems to be notified may be unavailable. Other features that may be useful (or essential to a robust solution) include:
The ability to filter notifications, so systems only receive notifications of interest to them. (This reduces network traffic).
Transactional support for notifications: notifications may only be removed from the persistent store when the system has successfully processed them.

The mechanism for performing these notifications may be the Java messaging service (JMS). Essentially JMS is a messaging API that was originally designed to wrap existing message oriented middleware (MOM). Since its introduction a significant number of pure Java implementations of JMS have been provided. JMS is part of J2EE 1.3.

By utilizing messaging in this way there may be created an appropriately looser coupling between the configuration server 126 and the other components. Using JMS also has another advantage in the OSS. JMS has been widely adopted by both newcomers to the MOM arena and established players. Where MOM is used in an OSS integration there may be a significant advantage in using a widely used and implemented mechanism. With wrappers around some of the major MOM (such as MQSeries) and adapters available from vendors to allow communication to other MOM systems (such as TIBCO Rendezvous), it provides significant integration potential—fulfilling the positioning of the product catalog as a place to integrate catalog information across the enterprise. This messaging interface allows easy integration with workflow systems.

EJB 2.0 introduced Message Driven Beans (MDB). These may be server side objects (that run in the EJB application server) that may be invoked by the server to handle messages delivered via JMS. The server may be responsible for the life cycle of the MDBs. Connecting MDBs with a particular JMS queue or topic is a deployment task, carried out by modifying the EJB deployment XML files. While MDB need not be used, it can provide an elegant mechanism for implementing some components that need to receive notifications from the configuration server 126.

JMS supports two types of communication: point-to-point and publish and subscribe. Publish and subscribe is the appropriate form for configuration change notifications: one notification may be made available to multiple OSS systems and other interested clients. Message publishers write messages to a topic, and message consumers read messages from a topic.

For reliable delivery of messages JMS supports:
Message persistence: messages may be maintained in a persistent form until they have been processed by a message consumer.
Durable subscriptions: JMS retains records of durable subscriptions and ensures that all messages from the topics publishers may be retained until they may be acknowledged by the durable subscriber (even if the subscriber is temporarily unavailable), or until the messages expire (message expiry is specified when the message is created).

The parties that are interested in notifications referred to as listeners in this document.

Listeners

The term listener may be used to describe clients or systems that are interested in changes to the configuration, but that do not need to participate in the configuration change process within the configuration server 126 (validating the change or applying it to an OSS component). Typically tools for editing the configuration may benefit from knowledge of changes to the CS content, but need not necessarily be guaranteed that they receive all updates. These are also not normally durable subscriptions—because the notifications are only required for the period when the configuration maintenance tool is actually being run.

Third parties may want to be notified about configuration changes. This can be achieved by registering to receive notifications. Notifications could then be sent as SOAP messages, delivered either by HTTP or via SMTP. Because acknowledgement of these notifications is not necessarily required, these may be not guaranteed reliable notifications. If guaranteed notification was required there would be a need to provide mechanisms to re-send notifications that had not been acknowledged.

Message Structure and Content

JMS allows for a variety of message formats including text, a map of name value pairs, bytes (i.e. some raw format), or serializable Java objects. Serializable objects may be used to communicate configuration item changes, and also to communicate audit records. (This is described further elsewhere in the following with details of discussion of auditing).

The message contains a header that describes aspects of the message. In addition to the mandatory header content, message publishers can provide additional header fields. Since the updates may incorporate changes to a number of configuration items (the CS has been updated using the configuration export tool), the update messages incorporate details of changes to a number of configuration items. This may be required because there can be circular dependencies between configuration items. The listeners may therefore need to deal with the configuration as a group.

The messages contain the following information:
Type of configuration entities changed. E.g. catalog details, category, or component.
The IDs of the entities that have been changed.
The type of changes: create, update, delete.

The message consumers can receive a filtered set of the messages, by configuring message selectors. The message selectors utilize a subset of the SQL92 expression syntax. This is a part of the JMS standard.

Publishers

The components that push configuration changes into the OSS may be referred to as publishers. The publishers may be implemented as session beans 210a. Essentially each publisher knows how to process configuration change method calls in order to update the OSS component for which it is designed. A publisher may only be interested in certain types of configuration changes. For example the CB 122 publisher may be only interested in CB 122 configuration items and not CM 124 configuration items or product catalog items.

The publishers also provide support for validating configuration changes prior to the change being committed to the configuration server 126 database and being sent to all publishers. Because the publishers invoke the various validations on configuration in the OSS, some changes may fail for some of the OSS components. It is typically very important to ensure that configuration (e.g. products) that may be invalid in one system are not created in another system. As an example, it would be inappropriate to create a product in the order entry system, making it available for sale, if it will not be created in the billing system.

The configuration server 126 supports ordering configuration changes so that the publisher for one system (e.g. CB) may be invoked before the publisher for another system (e.g. CM 124). The ordering policy can differ depending on the configuration item type.

The configuration server 126 records details of the configuration data stored by each publisher, including the OSS specific identifiers for configuration items. It may be possible for an update to fail for a particular system and therefore be only partially applied. An administration function can be used to locate these failed updates. The administrator can then deal with this situation as they see fit (e.g. remove the item if necessary, or correct whatever causes it not to be published in particular systems). The emphasis here is on providing mechanisms to find and fix errors, which should generally occur infrequently due to the validations that may be applied before committing any configuration. The administration console, described the Configuration GUI section herein, may be used to find these incomplete updates.

The publishers also support importing configuration from the OSS components that they handle, and reporting on the potential impacts of proposed configuration changes.

The configuration server 126 can import configuration from an OSS component and compare it with the copy that is stored within the configuration server 126 database. In this way a report of differences between the configuration server 126 copy of the configuration and the OSS is provided. This function may be accessible from the configuration server 126 administration console.

CS Storage

An Oracle database may be used to store the CS data. However, other similar databases can be used. XML databases can also be used for this purpose and may be desirable because of their support for validating XML and XML searching.

Oracle provides a range of support for XML storage. See (Oracle 9i Application Developer's Guide XML) for details. As of Oracle 9i the product supports a data type called XMLType. From the (Oracle 9i Application Developer's Guide—XML):

This Oracle-supplied type can be used to store and query XML data in the database. XMLType has member functions you can use to access, extract, and query the XML data using XPath expressions. XPath is another standard developed by the W3C committee to traverse XML documents. Oracle XMLType functions support a subset of the W3C XPath expressions. Oracle also provides a set of SQL functions (including SYS_XMLGEN and SYS_XMLAGG) and PL/SQL packages (including DBMS_XMLGEN) to create XMLType values from existing relational or object relational data.

XMLType is a system-defined type, so you can use it as an argument of a function or as the data type of a table or view column.

When you create a XMLType column in a table, Oracle internally uses a CLOB to store the actual XML data associated with this column. As may be true for all CLOB data, you can make updates only to the entire XML document. You can create an Oracle Text index or other function-based index on a XMLType column.

This has been described earlier with details on description of the objects that access the database.

Security

The security requirements for the CI, in some embodiments, may encompass:
Authentication of users that may be reading or modifying the catalog.
Authorization of reads and updates to the catalog.
Auditing changes to the catalog so that an administrator can determine who made a particular change and when it was done.

Although these security requirements were specified for product catalog data, they may be enforced for all configuration data.

The first three concerns are discussed in more detail in the following sections.

Further information of security in the J2EE environment can be found in documentation for Enterprise Java Beans, Version 2.0: http://java.sun.com/products/ejb.

The EJB specification encourages bean developers to avoid hard-coding security policies. This allows security policies to be set by the application assembler or application deployer.

Authentication

The authentication mechanisms available in an EJB application server may be vendor specific. The Java authentication and authorization service (JAAS) provides APIs for authentication and authorization, and supports pluggable authentication modules. It is an extension in J2SE 1.3, and fully integrated in J2SE 1.4. See Java™ Authentication and Authorization Service (JAAS) Reference Guide http://java.sun.com/j2se/1.4/docs/guide/security/jaas/JAASRefGuide.html for coverage of JAAS. However, J2EE vendors may not be required to support it, and at this time only some do. In J2SE 1.4 there are login (authentication) modules for:
JNDI: Can obtain login username/password from a directory service available via JNDI (e.g. LDAP).
Kerberos
NT login
Unix login
Using a keystore.

It is possible to support single sign-on using Kerberos, as described in Single Sign-on Using Kerberos in Java http://java.sun.com/j2se/1.4/docs/guide/security/jgss/single-signon.html. Therefore, the configuration server 126 defers to the application server for provision of authentication services.

Specific support may be provided for using JAAS for authentication when running the configuration server 126 under WebLogic server.

Authorization

In the J2EE architecture, the EJB and servlet containers act as authorization boundaries between callers and the components that they host. Permission based access control may be supported by compliant EJB and servlet containers. The deployment descriptor defines logical security roles and associates them with components (web resources (servlets), bean methods) to define the privileges that may be required to access components. The application assembler and deployer can use the declarative EJB deployment descriptors to define:
The privileges required to access components.
The correspondence between the security attributes presented by callers and the container privileges.

Additional programmatic authorization can be performed in an EJB by obtaining the role of the caller, via a standard API. The declarative authorization mechanisms of EJB 2.0 may be sufficient to support the authorization requirements specified for LMS (along with appropriate API design for the session beans 210a). Future requirements, e.g. for B2B partners accessing the catalog, may necessitate programmatic authorization checks as well and data-level authorization.

The configuration server 126 may be packaged with deployment descriptors that specify roles for the API that will be appropriate for most deployments. Additional programmatic authorization checks may be performed for create/update/delete operations to ensure that users have appropriate create/update/delete roles.

Auditing

J2EE containers may not be required to provide auditing facilities, and there may not be any standard auditing interfaces for containers to implement. Generally those that do provide auditing facilities actually normally only provide a basic level of functionality, namely logging security exceptions (authorization failures) and successful and unsuccessful authentications.

For this reason facilities were created in the configuration server 126 in some embodiments. Audit records may be written to a database table in the configuration server 126 database. (Notifications of the audit events may also be sent via JMS, as further described herein). The table contains:
The type of the configuration entity updated.
The id of the entity updated.
The type of operation (create, update or delete).
The date/time at which the change was made.
The XML representation of the item before (and after) the update.

The administration session bean provides an API for reading audit records. The administration console provides commands for searching for and viewing audit records.

Locking

The configuration server 126 supports locking of configuration. This is intended to allow a single configuration server 126 and related OSS components to be effectively used by a team of configuration developers.

The server can be set to require that a user must have a lock on any data that they wish to update in the configuration server 126 before the update will be allowed to proceed. This includes updates sent to the server by a client as well as updates to configuration via importing from an OSS component.

Details of the locks on configuration items may be stored in the configuration server 126 database. The session beans 210a described in the Configuration Server section herein provide APIs for user level changes to locks (lock and unlock items) and administrative access to locks (revoke and reassign locks).

CB 122 can be made to enforce the locks maintained by the configuration server 126. This may be achieved via database commit triggers on the CB 122 tables which in turn query the configuration server 126 to determine if the updates should be allowed to proceed.

Configuration Translation and Generation

In order to support the mapping of product data to low level CB 122 and CM 124 configuration, the configuration server 126 supports translating or generating configuration. The set of configuration generators is extensible. To add a generator to the system it is merely required to implement the generation session bean interface and add the new generator to a deployment descriptor entry listing the generators to use. This may be very similar to the way the set of validations may be extended, as further described herein.

The server supports the generation beans producing multiple configuration items from an input item and also producing lists of related items that will need to be updated (regenerated). The generation process also supports generation beans producing parts of configuration items that it can compose into a whole item before sending it to publishers. (These are called partial items). A configuration generator may be provided that uses XSLT stylesheets to perform the mapping. The stylesheets may be stored in the configuration server 126 database, in much the same way as other configuration items. A single stylesheet can product multiple configuration items. The following facilities may be provided in order to allow for sophisticated mappings:
Stylesheets can source other configuration items from the configuration server 126 database. This may be achieved by providing a special XML resolver that understands how to locate items in the configuration server 126 database. This resolver can also obtain old versions of configuration items.
An extension function may be provided for searching the configuration server 126 database for configuration items that match specific (XPath) criteria.

In one example embodiment, stylesheets may be provided for translating product catalog XML into CB 122 and CM 124 configuration suitable for use in a system using the EICP and CCITG configurations. Sample stylesheets may also be provided for some demonstration content-type products.

Execution Environment

The configuration server 126 component requires the following execution environment:
A system with the JRE version 1.3.1 or later.
A J2EE server, supporting version 1.3 of the J2EE specification.
A J2EE server supporting JAAS for authentication and authorization.

WebLogic Server 7.0 is the only certified J2EE server for initial release. EJB clients of the configuration server 126 require the following execution environment:
A system with J2SE version 1.4.1 or later.
   Configuration GUI

Overview

The workbench 144 component is a GUI for creating, updating, deleting and viewing product definitions. It is intended, in one example embodiment, to reduce the complexity of product management.

While the workbench 144 may be the only GUI component specified in on example embodiment for the LMS, future versions of the LMS may include GUIs for maintaining many other configuration items. The architecture takes this into account, by building on a framework into which other configuration management UI components can be added. Furthermore, rather than meeting the import/export, search, and version control requirements via command line tools, the LMS provides a GUI for performing import/export of configuration between repositories, searching configuration, configuration editing, and version control operations. This is called the configuration tools GUI.

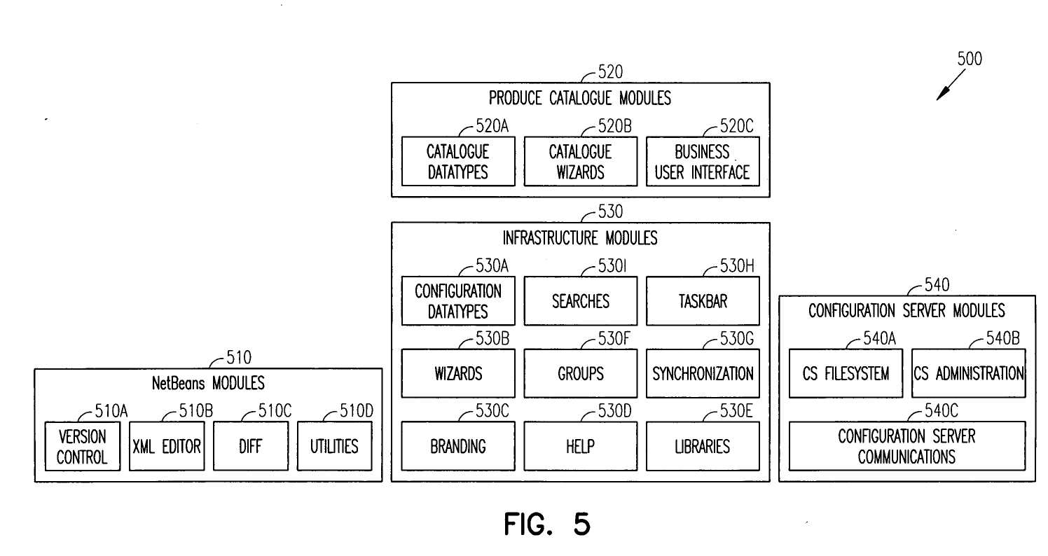

The workbench and configuration tools GUI 144 may be built on the NetBeans Open IDE framework, as depicted in FIG. 5. The figure depicts a system composed of a number of related modules 500, including Netbeans modules 510, product catalog modules 520, infrastructure modules 530 and configuration server modules 540. All run on top of the NetBeans OpenAPI framework. Modules 510 include a version control module 510a, a XML editor 510b, a Diff module 510c and a utilities module 510d. Modules 520 include catalog datatypes 520a, catalog wizards 520b and business user interface 520c. Modules 530 include configuration datatypes 530a, wizards 530b, branding 530c, help 530d, libraries 530e, groups 530f, synchronization 530h, and searches 530i. Modules 540 include CS file system 540a, CS administration 540b and configuration server communications 540c.

The NetBeans Open IDE framework provides the following core facilities:
Modules: Allows modular development of functionality, and plugging it into the framework. Modules can add items to menus, toolbars, help, add support for recognizing new types of files and actions appropriate to those, such as new edit components. This makes the configuration UI extensible.
Services: Such as import or export of configuration.
FileSystems: Abstract from access to file systems. Can be used to represent data retrieved from configuration server or configuration repository.
Data Types: Recognition of types of data.
Nodes: Used to represent data elements (configuration items, products, categories etc) and attach appropriate actions to them based on data type.
Explorer: Used to easily develop explorer interfaces, in conjunction with the nodes API.
Actions: Add menu and toolbar items for performing actions on the configuration items.
Editor: An editor may be built-in.
Window System: Provides window management facilities. Allows the user to run the application in multiple document interface or single document interface mode.
Options: Provides a mechanism for specifying configuration items for modules.
Utilities: Various useful utility classes.
Internationalization support: There is support for internationalization of the core and any modules.

See The NetBeans Tools Platform: http://www.netbeans.org/download/NetBeansToolsPlatform.pdf article from Dr Dobbs, for details of the services provided by the NetBeans Open IDE framework.

Netbeans Modules 510

Several of the standard Netbeans modules 510 may be included in the release of the configuration tools GUI or workbench. These may be:
Version control modules 510a: which provide support for CVS, and a generic VC system support that can be used to access configuration repositories.
XML module 510b: Which provides support for editing and validation of XML.
Editor module 510b: Useful for editing HTML or text documents which could accompany configuration.
Diff module 150c: Which provides support for comparison of files.
Utilities module 510d: Which provides support for searching files.

Infrastructure Modules 530

The configuration tools GUI and workbench contain a number of modules that may be useful with all configuration data to be handled by the LMS, rather than just the product data. They may be:
Configuration item datatypes module 530a: Provides support for recognizing flavors of XML.
Configurable searches module 530i: Provides support for searching for configuration items containing specific data.
Configurable wizard module 530b: Provides a framework for specifying wizard interfaces, using XML.
Grouping module 530f: Provides facilities for specifying groups of configuration data, and performing actions on the groups of configuration data.
Synchronization module 530g: Provides support for synchronizing files between repositories.
Taskbar module 530h.

These modules are described in more detail in the following sections.

Datatypes Module 530a

The configuration item datatypes module provides support for recognizing the various types of XML configuration item. It is then possible to associate appropriate icons and actions with the datatypes, and wizards suitable for editing the types of data.

This module also provides support for searching for specific types of configuration item.

The datatypes module provides the ability to show the references between configuration items in explorer views, and to create and delete references. There is also support for finding items that contain references to other items that do not exist in the repository.

Configurable Search Module 530i

The configurable search module provides support for searching for particular configuration items based on their content. (The NetBeans utility module provides the ability to search based on simple text content, modification date, and version control status). This search allows users to search for named fields in the configuration XML containing specified values. (Or starting or ending with specified values, or matching a regular expression).

The searches may be implemented using XPath. The displayed names of the searches, fields and XPath expressions may be specified in XML configuration files.

Configurable Wizard Module 530b

The Configurable Wizards Module 530b provides support for defining wizards. The wizards are intended to create or modify XML for configuration entities. The creation or update of configuration XML for a particular type of configuration item may be basically viewed as involving the following activities:
1. Collecting sufficient information to describe the required configuration.
2. Placing that information in the required XML structure.
3. Saving that configuration data, exporting the data to the OSS, or sending the data to a server via API calls.

The data to be collected may be described in a wizard definition. The definition contains steps, which in turn contain fields. Each field represents an XML fragment, as does a wizard. (A wizard can be used as sub-wizards, or initiated from other wizards to build up complicated XML). Essentially then these fields and sub-wizards provide arbitrary XML fragments that can be composed, with the aid of a template, to create the desired XML.

Obviously the output XML may need to contain values derived from the XML fragments collected, and this may be done by applying expressions to the collected fields. This may be done using expression languages. The primary supported expression language may be XPath, an expression language specifically designed for dealing with XML See XPath Specification at http://www.w3.org/TR/xpath. It would be possible to add support for other scripting languages that run in a JVM. For example, JavaScript, Python, etc—see list of scripting languages available for Java: http://grunge.cs.tu-berlin.de/˜tolk/vmlanguages.html.

Wizards vary their behavior based on information that has been previously entered. This may be accomplished by skipping steps or sub-wizards based on expressions (using the built-in expression support) calculated from previous inputs.

Input data may be validated at the field, step and wizard level. Validations may be either plugged in Java classes that conform to an interface, or classes that implement their validation using one of the supported expression languages.

The wizard definition must includes additional information:
Display names and descriptions for the wizards, steps and fields. It may be possible to translate these into multiple languages and render the wizard using the users language of choice.
Help details for the wizards, steps and fields so that appropriate online help can be displayed.

Once the wizard has been completed its XML output is processed in some manner. This may be achieved by plugging in a Java class that conforms to a standard interface. For the product builder, classes may be provided to save the XML to a repository.

Configuration Grouping Module 530f

The grouping module builds on the datatypes, searches and wizard modules. It provides:
Support for recognizing group XML files.
Support for viewing the items referenced by groups and actions to add and remove items from a group.
Wizards for creating and editing groups.
Searches for finding groups containing specific data.

Synchronization Module 530g

The synchronization module provides a wizard that allows users to synchronize some or all of the configuration held in two different configuration repositories.

It allows the user to select the repositories to be synchronized, and presents them with explorer views containing the contents of each repository and a merged view that indicates the differences between the repositories. Using these view users can select configuration to be synchronized.

The ability to search for configuration or select configuration that the user has locked, or simply all configuration data that differs between the repositories may be also provided.

Taskbar Module 530h

The taskbar module provides a simple to use interface for launching tasks such as creating a product catalog or catalog item, or searching for a particular item. A product catalog specific module provides actions that appear in the taskbar.

Product Catalog Modules 520

The following modules implement the remainder of the functionality supported by the workbench 144:
Product catalog datatypes module 520a.
Product catalog wizards module 520b

Product Catalog Datatypes Module 520a

The product datatypes module contains the configuration required to recognize the product catalog configuration items using the datatypes module. That is, the catalog, category, charge type and component configuration items.

The product catalog datatypes module provides actions associated with the product catalog datatypes, including the ability to launch a catalog explorer view. This may be an explorer view with an attached property sheet. The explorer view has product catalogs as root elements. It allows users to view the associated product categories and products (components) and charges as children of the catalog. Details of items selected in the explorer view as shown in the property sheet.

Product Catalog Wizards Module 520b

The product catalog wizards module contains the XML files that specify the wizards for manipulating CI data. In one example embodiment, sample wizards for editing some types of EICP products may be provided.

Configuration Server Modules 540

The following modules implement the client functionality for accessing and managing the configuration server:
Configuration server file system module 540a
configuration server administration module 540b

Configuration Server File System Module 540a

The configuration server file system module 540a represents the contents of the configuration server 126 as a virtual file system (or repository), in the same way that other repositories such as CVS or local directories may be presented to the user. This allows users to examine the server contents via an explorer view (of folders and files) and to copy and paste configuration data between repositories.

The configuration server file system annotates configuration items with their status in the server (such as revision number and lock details). It may be kept in sync with the server by responding to configuration change notifications sent by the server. It caches the server contents locally to avoid repeated fetches of the same data from the server.

The file system module 540a makes use of the client stubs and business delegates for calling the configuration server 126.

Configuration Server Administration Console 540b

The configuration server administration console may be launched via an action provided in the configuration server file system module 540a. It provides a user-interface for administration of various aspects of the configuration server 126.

It should be noted that tools for administration of the application may be split based on the lines of responsibility for provision of services. That is, many services may be provided by the application server, or by other servers (such as an LDAP or Kerberos server providing user authentication support). Management of these “parts” of the configuration server 126 may be performed using whatever tools are provided by the vendors the supply these components. No attempt has been made to wrap their functionality in an over-arching management user interface.

The administration console 540b provides what may be essentially a command line interface (albeit in a GUI window). The commands it supports include:
The capability to view the contents of the configuration server 126 (files and revisions), and the updates that have been applied to the server.
The ability to update configuration stored in the server. This includes updating from local files and updating from the OSS.
The ability to update the OSS from the data stored in the server.
The capability to find and view audit records stored in the server.
The ability to modify various server settings: e.g. trace, locking, auditing, server name and description.
The ability to obtain composite product catalog definitions.
The ability to lock and unlock configuration items.
Update the set of stylesheets used for configuration generation.
Set the update ordering that controls the order that configuration is sent to the various publishers.

The configuration server console can also be run standalone in a terminal window. This version may be packaged with the configuration server 126.

Execution Environment

The configuration tools GUI and workbench components require the following execution environment:
A system with the J2SE version 1.4.1.

License Management

Licensing information may be specified for both the client GUIs and configuration server 126. For example, the client licensing may be on a module basis. Or, the server licensing may restrict the number of connected users, the systems that a configuration server 126 can be connected to and the features of the configuration server 126 that clients can use.

License information may be encapsulated in an XML file format, which may be cryptographically signed to prevent tampering. In the GUIs the license file may be read, and modules may be enabled/disabled based on its contents. Clients must have a copy of a valid license in the installation directory of the client.

The configuration server 126 may communicate with a separate license process. This may be a separate process that counts connected users across multiple instances. That is, a single license server can be used for multiple configuration servers 126. The configuration server 126 may communicate with the license manager via remote method invocation, and obtain a handle to the license manager via the Java naming and directory interface.

In one embodiment, when clients connect to the configuration server 126 they request the client licenses that they need (basic configuration license or product catalog license). The server also checks the license when publishers are invoked to import/export configuration.

Execution Environment

The license server requires the following execution environment:
A system with the J2SE version 1.3.1.

RelGen

RelGen is a release management system. It manages items that are to be included in a release, and creates a release package that includes these items or the deliverable items created from the managed items. RelGen may be used to release CB 122 configuration. It uses the CB 122 archiver.

RelGen is, in one example embodiment, adapted to support:
Releasing configuration in XML format from a version control system (CVS) or local file system. This may be implemented via RelGen plugin modules.
Installing configuration in XML format via a configuration server 126.
Release of configuration as a CB 122 archive by first loading the configuration into CB 122 via a configuration server 126.
Supporting the use of group files to select configuration to be released.

As RelGen may be written in Perl the implementation of these RelGen plugins requires that the configuration server 126 API and configuration groups API described in the Configuration Server section herein and be made available in Perl. The Perl wrappers for the Java APIs are implemented using JPL. One possible modification to the NetBeans CVS module may provide hooks that can be used to update the RelGen database when configuration items are committed to CVS.

Interfaces

The Lifecycle Management Suite consists of a number of components. It can be integrated with external systems; for example, a Customer Management Relationship (CRM) system or web interface. The functionality of Lifecycle Management Suite can be extended through implementing Lifecycle Management Suite interfaces or writing extra code that calls existing Lifecycle Management Suite interfaces.

The interfaces described in this section can be separated into two groups, those that are called and those that are implemented. For this document, interfaces that are called are referred to as APIs (Application Programming Interfaces), and interfaces that are implemented are referred to as an interface. Calling an API means using the methods provided by the API. Implementing an interface means writing code that adheres to the interface definition so that the interface can be called by existing Lifecycle Management Suite code. For example:
Importing configuration to the Configuration Server involves calling the Configuration Server Client API.
Creating a new publisher for an OSS involves implementing the Publisher interface.

LMS as a Master

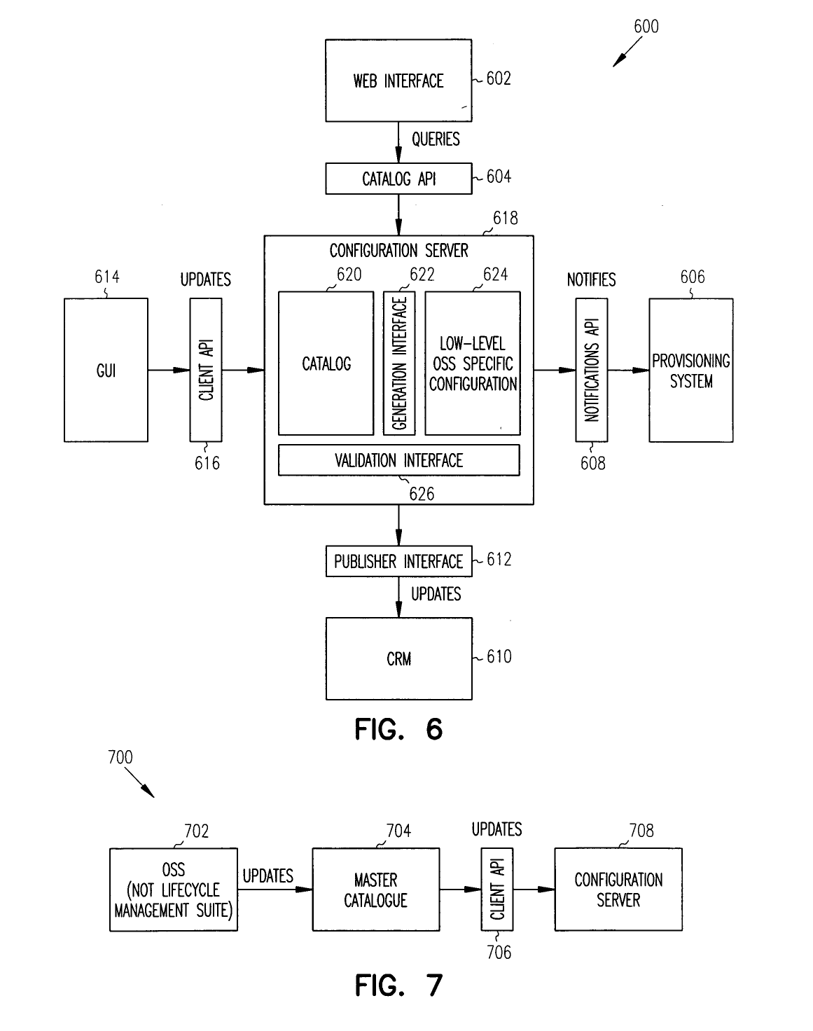

FIG. 6 provides an exemplary embodiment of a system 600 where LMS is a master. Updates are made to the Catalog 620, stored in the Configuration Server 618, via a GUI 614. Further, other systems (i.e., 602, 606, 610) can interact with the Configuration Server 618.

Configuration Server

The Catalog 620 is stored in the Configuration Server 618 and accessed by systems querying it. Two interfaces are used inside the Configuration Server 620:
Configuration Generation interface 622 and
Validation interface 626.

The Configuration Generation interface 622 encompasses the XSLT stylesheets used to translate high-level Catalog configuration to low-level OSS specific configuration 624. Components conforming to the Validation interface 626 are used to validate configuration changes. If the validation fails, the changes will not be applied to the Configuration Server 618 maintaining the integrity of the configuration.

GUI

Updates are made to the Catalog 620 using the Lifecycle Management Suite GUIs 614. The Configuration Server Client API 616 provides create, update, and delete operations on configurations. These operations are used by the Lifecycle Management Suite GUIs 614 to perform the requested actions on configuration in the Configuration Server 618.

Web Interface

The web interface 602 does not maintain a copy of the Catalog 620. The read-only Catalog API 604 is used to query and view the Catalog 620 within the Configuration Server 618. The Catalog API 604 allows searching of the Configuration Server 618 for catalogues and catalogue components, such as charge types, and searching contents of a specified catalogue.

Provisioning System

When changes to a configuration occur, systems can either be directly updated as part of the update or notified by asynchronous notifications. In the exemplary embodiment of system 600, the provisioning system 606 maintains a slave copy of the Catalog 620 kept in synchronization with the master copy by notifications. The notifications are handled by the Configuration Server Notifications API 608.

Customer Relationship Management (CRM)

Again as shown in system 600, the CRM 610 is updated directly, like Convergent Billing and Customer Management. The updates are performed by components implementing the Publisher interface 612. Having the slave copy updated as part of the update to the master copy results in a tighter coupling between the two components. Also, systems participating in direct updates can have changes made by that system imported back to the Configuration Server 620, unlike systems receiving notifications.

LMS as Slave

FIG. 7 provides an exemplary system 700 embodiment of LMS as a slave. Updates to the master catalogue 704 are made through a system other than Lifecycle Management Suite, and that system 700 maintains the master catalogue 704.

Reasons to maintain a slave copy rather than query the master copy are:
It is quicker to query and view a slave copy than access the master catalogue 704.
The OSS 702 component is incapable of reading the master copy.

In system 700, the Configuration Server Client API 706 is used to update the Configuration Server 708. This can either be done as part of each update or as a batch update at specified intervals.

It is understood that the above description is intended to be illustrative, and not restrictive. Many other embodiments will be apparent to those of skill in the art upon reviewing the above description. The scope of the invention should, therefore, be determined with reference to the appended claims, along with the full scope of equivalents to which such claims are entitled.

1. A method comprising:
storing by a configuration server a configuration, the configuration including a plurality of configuration items wherein the configuration server is a master with respect to a first subset of the configuration items and a slave with respect to a second subset of the configuration items;
receiving a change in at least one of the configuration items in the first subset;
updating the configuration in accordance with the change in at least one of the configuration items in the first subset;
sending a notification of the change via a messaging system;
translating the configuration into an OSS component specific configuration; and
sending the OSS component specific configuration to an OSS component.

2. A method comprising:
storing by a configuration server a configuration, the configuration including a plurality of configuration items wherein the configuration server is a master with respect to a first subset of the configuration items and a slave with respect to a second subset of the configuration items;
receiving from an OSS component a change in an OSS component specific configuration;
translating the OSS component specific configuration into at least one of the configuration items in the second subset; and
updating the configuration in accordance with the change in at least one of the configuration items in the second subset.

3. The method of claim 2, further comprising:
sending a notification of the change via a messaging system.

4. A method comprising:
storing by a configuration server a configuration, the configuration including a plurality of configuration items wherein the configuration server is a master with respect to a first subset of the configuration items and a slave with respect to a second subset of the configuration items;
receiving a change in at least one of the configuration items in the first subset;
updating the configuration in accordance with the change in at least one of the configuration items in the first subset;
translating the configuration into an OSS component specific configuration;
sending the OSS component specific configuration to an OSS component;
receiving from an OSS component a change in an OSS component specific configuration;
translating the OSS component specific configuration into at least one of the configuration items in the second subset; and
updating the configuration in accordance with the change in at least one of the configuration items in the second subset.

5. The method of claim 4 further comprising:
sending a notification of the change via a messaging system.

6. A computer system comprising one more component programs operable on the system that manage configuration of telecommunications operations software over bidirectional interfaces that allows communication between components, wherein individual components are master to some configuration settings and slave to other configuration settings, further wherein, with respect to a specific configuration setting, a master sends updates over the bidirectional interface to slave components according to a received configuration modification

7. The computer system according to claim 6 wherein the components include provisioning software, customer support software, and billing software.

8. A computer system comprising one more component programs operable on the system that manage configuration of telecommunications operations software over bidirectional interfaces that allows communication between components, wherein individual components are master to some configuration settings and slave to other configuration settings, further wherein, with respect to a specific configuration setting, a slave updates its configuration in accordance with a configuration modification received from a master over the bidirectional interface.

9. The computer system according to claim 8 wherein the components include provisioning software, customer support software, and billing software.
